(19) United States
(12) Patent Application Publication
(10) Pub. No.: US 2012/0324540 A1
(43) Pub. Date: Dec. 20, 2012

(54) SYSTEM AND METHOD FOR THE INTEROPERABILITY OF PERSONAL ELECTRICAL APPLIANCES

(75) Inventor: Chun-Ting Wu, Taipei County (CN)

(73) Assignee: FLEXTRONICS AP, LLC, Broomfield, CO (US)

(21) Appl. No.: 13/224,259

(22) Filed: Sep. 1, 2011

Related U.S. Application Data
(63) Continuation-in-part of application No. 12/947,588, filed on Nov. 16, 2010.

(51) Int. Cl. G06F 21/20

(52) U.S. Cl. 726/4

(57) ABSTRACT

Systems for, and methods of, enabling selective control of resource of an electronic device having a display by a controlling electronic device wherein one device is housed within the other and each device having a display are disclosed. Selective control of the electronic device is implemented by the electronic device via a set of control permissions for a detected controlling device, based upon an identifier of the controlling device. A controlling device can be any electronic device having a processor, a memory, a display and a communication module. Enabling selective control of the display of an electronic device having a display, by a personal computer, enables the personal computer to operate as a dual screen personal computer.

### RELATED APPLICATIONS

This application is a Continuation in Part of U.S. patent application Ser. No. 12/947,588 entitled “Dual Screen PC” filed Nov. 16, 2010, which is incorporated herein in its entirety.

### FIELD OF THE INVENTION

The present invention relates to the field of electronic devices having a display screen. More specifically, the present invention relates to systems for and methods of enabling selective control and interoperability of two or more electronic devices having a display.

### BACKGROUND OF THE INVENTION

Many consumers own several electronic devices, each of which includes a processor, a display, a memory, and a communication module for communicating with other electronic devices. Such electronic devices can include a digital picture frame, a cell phone, a Smart Phone, a digital music player, a digital camera, a digital camcorder, an electronic book reader (e-book), a display panel with a processor and a memory, a personal digital assistant (PDA), a pocket personal computer (PC), a tablet PC, a laptop PC, a notebook PC, and a desktop PC. Most of these also have an input device and audio processing capabilities.

Current electronic devices have only limited ability to inter-operate with other electronic devices. Interoperability, if any, between devices is largely application-specific. For example, a desktop PC running Microsoft® Outlook® can interoperate with certain PDA's, such as the Hewlett-Packard® Pocket PC, to synchronize mail folders, contacts, tasks and other data. In a synchronization operation, the desktop PC is a controlling device and the Pocket PC is a controlled device. An application on the desktop PC, Microsoft® ActiveSync®, allows the user to specify which data will be synchronized, and the method of synchronization. The Pocket PC has a corresponding ActiveSync® agent which responds to the requests by ActiveSync® on the desktop PC. The ActiveSync® agent on the Pocket PC permits configuration of some parameters of the synchronization process. There is no permission set on the Pocket PC, associated with an identifier of the desktop PC, permitting the desktop PC to control the display of the Pocket PC independent of the ActiveSync® application. Other software tools, similar to ActiveSync®, exist for synchronizing music between a desktop PC and a digital music player, and for backing up contact information on a cell phone to a server. Synchronization applications do not enable an electronic device to specify a set of control permissions characterizing the control that the electronic device will permit to a detected and identified controlling device, independent of the synchronization application.

Current electronic devices do not enable selective control of a resource on the electronic device, by a controlling electronic device, according to a set of control permissions associated with an identifier of the controlling device, and independent of a specific software application.

### SUMMARY OF THE INVENTION

What is provided is a system and corresponding method for the interoperability of two or more electronic devices, each having a separate processing capability, communication means and interface including, for example, a keyboard and a screen. In several embodiments of the disclosed concept, a controlled electrical device, such as a tablet PC or a smartphone/pocket PC are physically housed within a controlling electrical device, such as a laptop computer. The controlling electrical device can take advantage of the several resources within the controlled device, such as audio or video resources, and also take advantage of capabilities of the controlled device, such as cellular broadband, cellular telephony, or processing capabilities. A user can dock a controlled device into a controlling device, and in essence operate them independently via a shared interface. Alternatively, the user can operate the controlled device through the controlling device through a single interface.

In a first aspect of the invention, a system comprises a first electronic device including a first processor, a first display, a receptacle for receiving a second electronic device, the receptacle having a first communication module, and a memory programmed with instructions implementing a method of enabling, by the first electronic device, selective control of a resource of the second electronic device accordance with a set of control permissions associated with an identifier of the second electronic device when the second electronic device is housed within the receptacle, and a second electronic device including a second processor, a second display, a second communication module, an input device, a memory, and an identifier. Preferably, the first communication module and second communication module operate to enable the first electronic device to detect the presence of the second electronic device and to retrieve the identifier of the second electronic device. The first and second communication modules can be, for example, a proprietary connector configured to mate upon insertion of the second device into the first device. Also, the first processor and second processor operate to enable the first electronic device to retrieve a set of control permissions associated with the identifier of the second electronic device. The control permissions can be set by a user or a manufacturer, or some combination thereof. Still, the first electronic device and the second electronic device are each independently operable from the other.

In some embodiments, the first electronic device is a desktop computer, the second electronic device is a tablet computer detected and identified by the desktop computer, and the tablet computer implements a set of control permissions enabling selective control of the tablet computer display by the desktop computer. For example, the set of control permissions further enables selective control of the tablet computer audio by the desktop computer. The first electronic device further should have a charging means for the second device, and the set of control permissions enable the second device to selectively control a charging means. For example, the second device can communicate to the first device a level of charge and facilitate charging accordingly.

Alternatively, the first electronic device is a desktop computer, the second electronic device is a smartphone detected and identified by the desktop computer, the smartphone having broadband connectivity or other cellular telephony means, and the desktop computer implements a set of control permissions enabling selective control of the smartphone broadband connectivity or cellular telephony means by the desktop computer. In such an embodiment, the set of control permissions enable selective control of the smartphone broadband connectivity means, thereby enabling broadband connectivity in the desktop computer. Such an embodiment can obviate the need for a separate broadband connection for a tablet PC and a home desktop PC.

In another aspect of the invention, a method of enabling selective control of a resource of an electronic device having a display comprising implementing, by the electronic device, a set of control permissions for a detected controlling device having a display, based on an identifier of the controlling device, when the electronic device is inserted into the controlling device. Preferably, the method also includes establishing, by a user of the electronic device, a set of control permissions for the controlling device and retrieving a stored set of control permissions associated with the identifier of the controlling device. A resource can be a video resource, an audio resource, a memory resource, or a wireless connectivity resource such as wi-fi, cellular telephony or cellular broadband. In some embodiments, a resource is the display on the electronic device, and the set of control permissions enables the controlling device to control the display on the first electronic device. A user is able to manipulate the electronic device via window on the controlling device, where the window is a visual representation of the display of the electronic device. Optionally, a resource is a cellular broadband resource on the first electronic device, and the set of control permissions enables the second electronic device to control the cellular broadband connectivity of the second electronic device by the cellular broadband resource on the first electronic device, thereby enabling cellular connectivity in the controlling device. The set of control permissions for the controlling device can enable the controlling device to exclusively control a resource on the electronic device. In some embodiments, enabling selective control of a resource of the electronic device is independent of an application running on the controlling device. A plurality of sets of control permissions can be associated with an identifier of the controlling device, or a set of control permissions can corresponds to a selective control mode. A selective control mode can be an audio mode, an audio-visual mode, an input mode, a wireless connectivity mode, and a charging mode. A selective control mode can be implemented on the electronic device based on the identifier of the detected controlling device. For example, if a smartphone having cellular telephony capability is inserted into and housed within the controlling device, the controlling device, after checking for permission, can assume control of the cellular telephony module of the smartphone, thereby enabling cellular telephony in the controlling device. Similarly, an audio-video selective control mode can implemented on the electronic device based on the identifier corresponding to a particular desktop computer controlling device. For greatest convenience, the controlling device can be detected and identified a first time during a coupling the electronic device with the controlling device, and subsequently the controlling device is detected and identified by communicating with the electronic device. At the end of a session, the selective control can be terminated.

In another aspect of the invention, an electronic device comprises a processor, a display, a receptacle for receiving a controlled device, a communications module, and a computer-readable medium programmed with instructions for enabling selective control of a resource of the electronic device by implementing a set of control permissions for a detected controlled, based on an identifier of the controlled device when the controlled device is housed within the receptacle. Preferably, the receptacle further comprises a communication module for detecting the controlled device and/or a means for identifying the controlled device.

### BRIEF DESCRIPTION OF THE DRAWINGS

FIG. 1 shows a tablet PC coupled by a mount to a desktop PC, according to some embodiments.

FIG. 2 shows a digital picture frame coupled to a desktop PC, according to some embodiments.

FIG. 3 shows a tablet PC communicatively coupled to desktop PC, according to some embodiments.

FIG. 4 shows a digital picture frame having audio and external speakers, communicatively coupled to a Smart Phone, according to some embodiments.

FIG. 5 illustrates a method of selectively enabling control of a controllable device according to some embodiments.

FIG. 6A shows a front view of a mountable, independently operable tablet PC according to some embodiments.

FIG. 6B shows a rear view of the tablet PC of FIG. 6A with the mount in its stored position, according to some embodiments.

FIG. 6C shows a rear view of the tablet PC of FIG. 6A with the mount in its open position, according to some embodiments.

FIG. 6D shows a front view of the tablet PC of FIG. 6A being mounted into a mount on a desktop PC according to some embodiments.

FIG. 7A shows the identification properties of a set of control permissions, according to some embodiments.

FIG. 7B shows the audio properties of a set of control permissions, according to some embodiments.

FIG. 7C shows the video properties of a set of control permissions, according to some embodiments.

FIG. 7D shows the input properties of a set of control permissions, according to some embodiments.

FIG. 7E shows the miscellaneous properties of a set of control permissions, according to some embodiments.

FIG. 7F shows the communication properties of a set of control permissions, according to some embodiments.

### DETAILED DESCRIPTION OF THE DRAWINGS

The systems and methods described herein enable selective control of a resource of an electronic device having a display. The selective control is implemented by the electronic device via a set of control permissions for a detected controlling device, based on an identifier of the controlling device.

The following figures illustrate features of specific embodiments of the presently-claimed invention. Throughout the figures, below, identical labels refer to identical or similar elements. The following embodiments are intended to illustrate the features of the presently-claimed invention. The invention is not limited to only the disclosed embodiments.

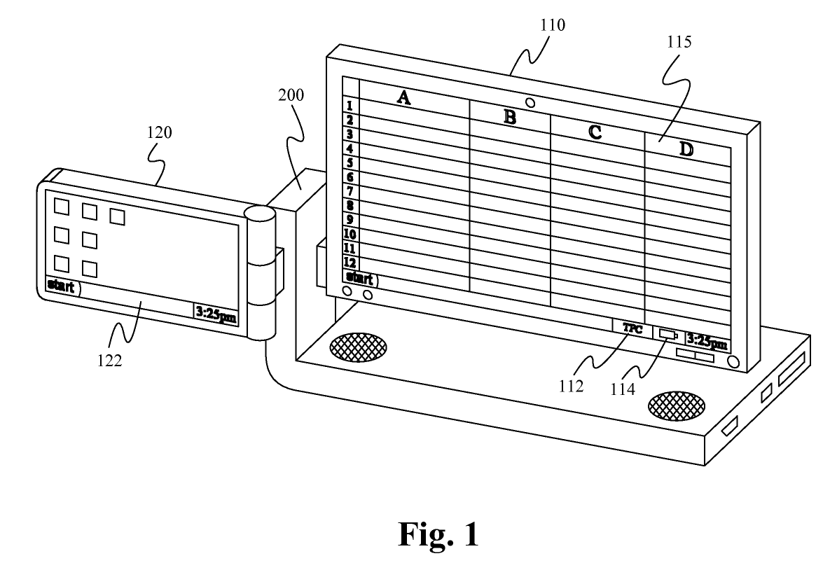

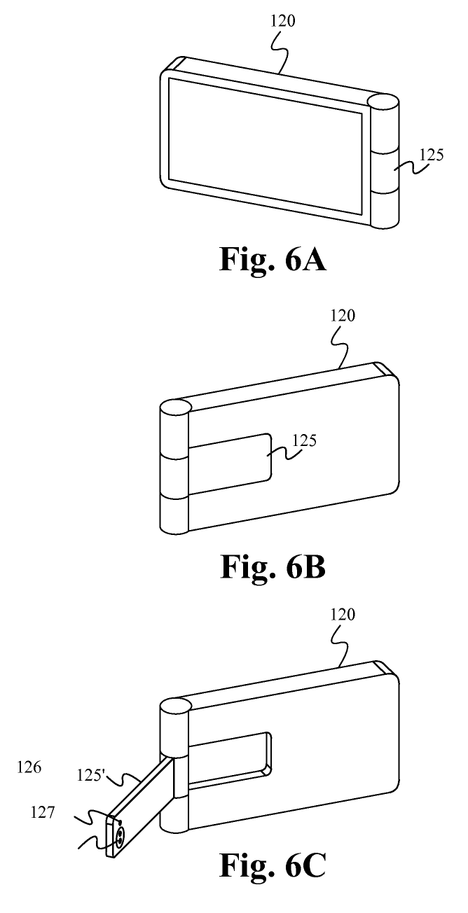

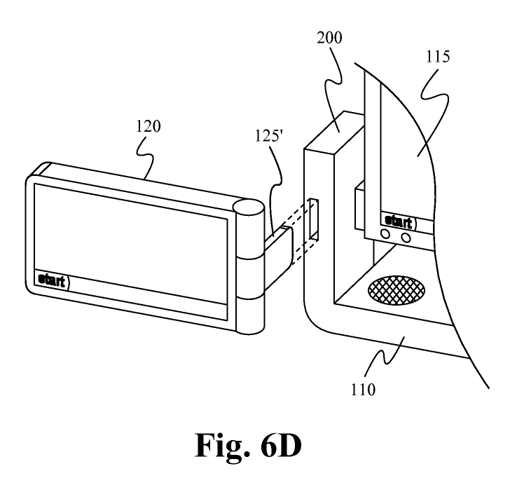

FIG. 1 shows a desktop PC 110 coupled by a mount 200 to a tablet PC 120. As shown in FIGS. 6A-6D, below, the mount 200 can comprise means for detecting the coupling of the tablet PC 120 with the desktop PC 110, and can further comprise means for charging the tablet PC 120. In this embodiment, the desktop PC is an electronic device having a display, enabling selective control of the charging resource in the mount by the tablet PC. The desktop PC 110 detects the presence of tablet PC 120 and displays an icon 112 on the desktop PC display 115 indicating that the tablet PC 120 has been detected and identified, and that a set of control permissions has been retrieved and implemented on the desktop PC 110. The set of control permissions on the desktop PC 110 enable selective control of the charging means in the mount 200 by the tablet PC 120. An icon 114 on the desktop PC display 115 indicates that the tablet PC 120 can selectively control the charging function on the desktop PC 110. When the tablet PC 120 reaches full charge, the tablet PC 120 can turn off the charging function of the desktop PC 110. When the charging function is turned off, the icon 114 can be removed from the desktop PC display 115, or the color of the icon 114 can change to indicate that the charging function is turned off. In this embodiment, the desktop PC 110 and the tablet PC 120 are independently operable, other than the charging function described above. Thus the tablet PC display 122 is under control of the tablet PC 120, and the desktop PC display 115 is under control of the desktop PC 110. The desktop PC 110 is running a spreadsheet application, and the tablet PC 120 is at the start menu with no application open or running.

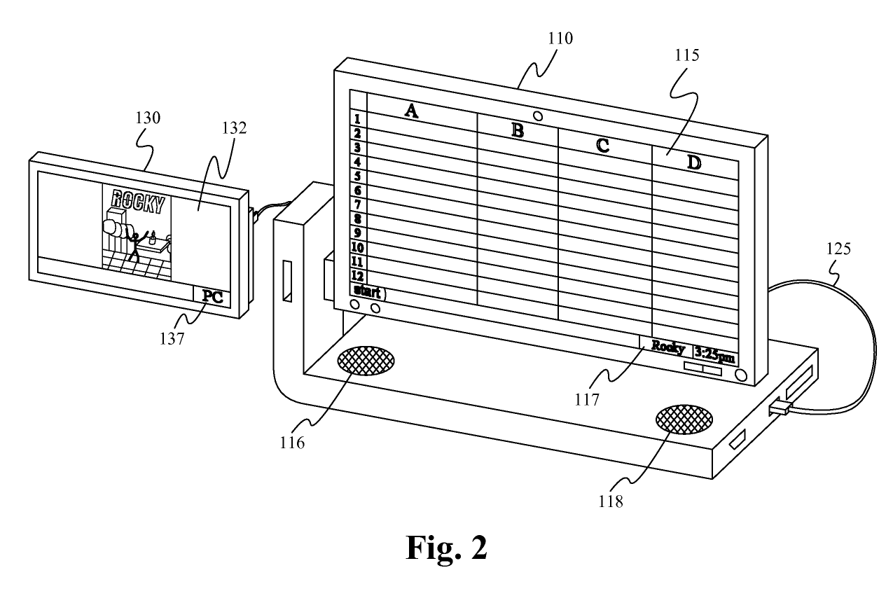

FIG. 2 shows the desktop PC 110 coupled to a digital picture frame 130 using a USB cable 125. The digital picture frame display 132 shows an icon 137 titled “PC” indicating that the desktop PC 110 has been detected and identified by the digital picture frame 130, and that the digital picture frame 130 has retrieved and implemented a set of control permissions enabling selective control of a resource on the digital picture frame 130 by the desktop PC 110. In this embodiment, the digital picture frame 130 does not support audio. Accordingly, the set of control permissions on the digital picture frame 130 associated with an identifier of the desktop PC 110 does not permit control of the digital picture frame audio resources because the digital picture frame 130 does not support audio. The digital picture frame 130 operates as a second display of the desktop PC 110. The desktop PC 110 is running a spreadsheet application as shown on the desktop PC display 115. The desktop PC is also streaming the video of “Rocky” to the digital picture frame screen 132 as shown by icon “Rocky” 117. The soundtrack for the movie Rocky is played over the desktop PC speakers 116 and 118 because the digital picture frame does not support audio. Control of the digital picture frame 130 by the desktop PC 110 can be terminated by any of: powering off the digital picture frame 130, powering off the PC 110, ending the application showing the movie, the digital picture frame 130 terminating the permission for the desktop PC 110 to control the display 132 of the digital picture frame 130, or by disconnecting the USB cable 125, thereby decoupling the desktop PC 110 from the digital picture frame 130.

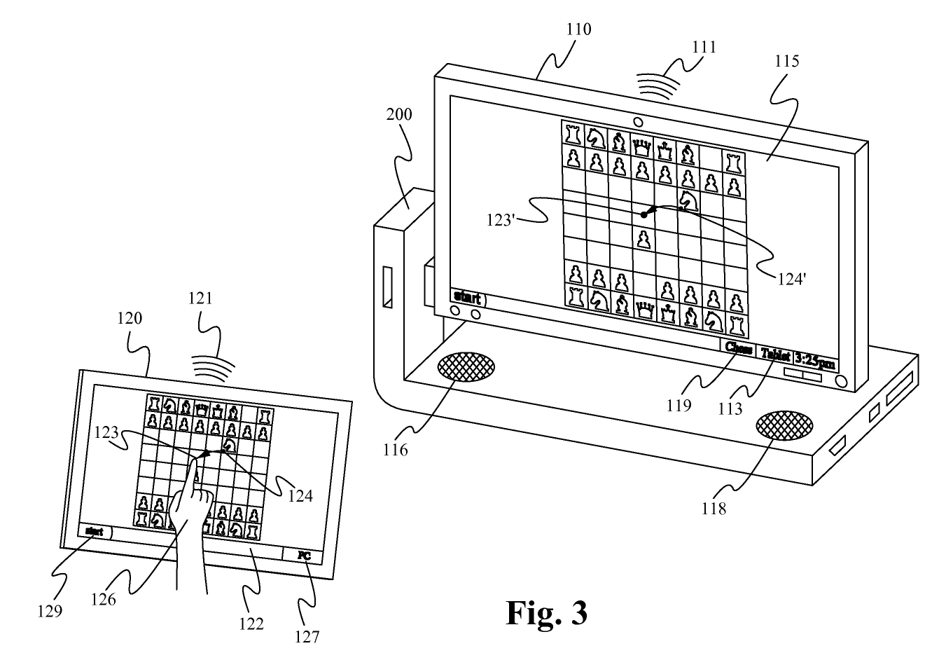

FIG. 3 shows the desktop PC 110 having a wireless communication adapter 111 in communication with a tablet PC 120 having a wireless communication adapter 121. In this embodiment, the desktop PC 110 permits the tablet PC 120 to control the desktop PC inputs. The tablet PC 120 permits the desktop PC 110 to control the tablet PC display. An icon 113 “Tablet” on the desktop PC display 115 indicates that the desktop PC 110 has enabled selective control of a resource on the desktop PC 110 by the tablet PC 120. The icon “PC” 127 on the tablet PC display 122 indicates that the tablet PC 120 has enabled selective control over a resource on the tablet PC 120 by the desktop PC 110. The desktop PC 110 has permitted the tablet PC 120 to control the desktop PC 110 inputs. The tablet PC 120 effectively becomes a remote controller of the desktop PC 110. The desktop PC 110 is running a chess game application as shown on the desktop PC display 115 and the icon “Chess” 119 on the desktop PC display 115. A user of the tablet PC 120 moves a chess piece by touching the tablet PC display 122 with their finger 126 and dragging the chess piece from a location 124 to a new location 123. The desktop PC 110 processes the input and updates the location of the chess piece from a corresponding location 124′ to the new corresponding location 123′ on the desktop PC display 115. The desktop PC 110 then updates the tablet PC display 122, thereby making the tablet PC 120 operate as a remote controller of the chess game on the desktop PC 110. As indicated by the lack of a chess game icon in the task bar 129 of the tablet PC 120, the chess game is not running on the tablet PC 120. The tablet PC 120 is controlling the inputs to the chess game as the chess game runs on the desktop PC 110.

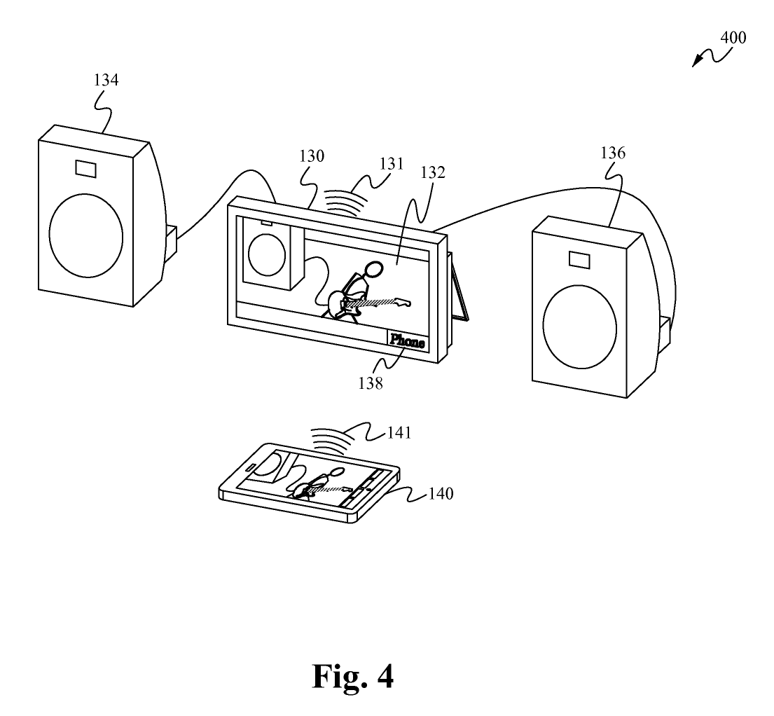

FIG. 4 shows a Smart Phone 140 with a wireless adapter 141 communicatively coupled to the digital picture frame 130′ having a wireless adapter 131 and audio capabilities for driving speakers 134 and 136. The digital picture frame 130′ has detected and identified the Smart Phone 140 and implemented a set of control permissions for enabling the Smart Phone 140 to selectively control the digital picture frame display 132 and the digital picture frame audio to drive speakers 134 and 136. An icon 138 “Phone” on the digital picture frame display 132 indicates that one or more resources on the digital picture frame 130′ can be controlled by the Smart Phone 140. A user is playing a music video on the Smart Phone 140. The music video is displayed on the digital picture frame screen 132 and the audio is played over the speakers 134 and 136. The Smart Phone 140 can be configured to simultaneously display the video and play the audio on the Smart Phone 140 and on the digital picture frame 130′, thereby creating a dual screen Smart Phone. Alternatively, the Smart Phone 140 can operate independently of the music video being played on the digital picture frame 130′.

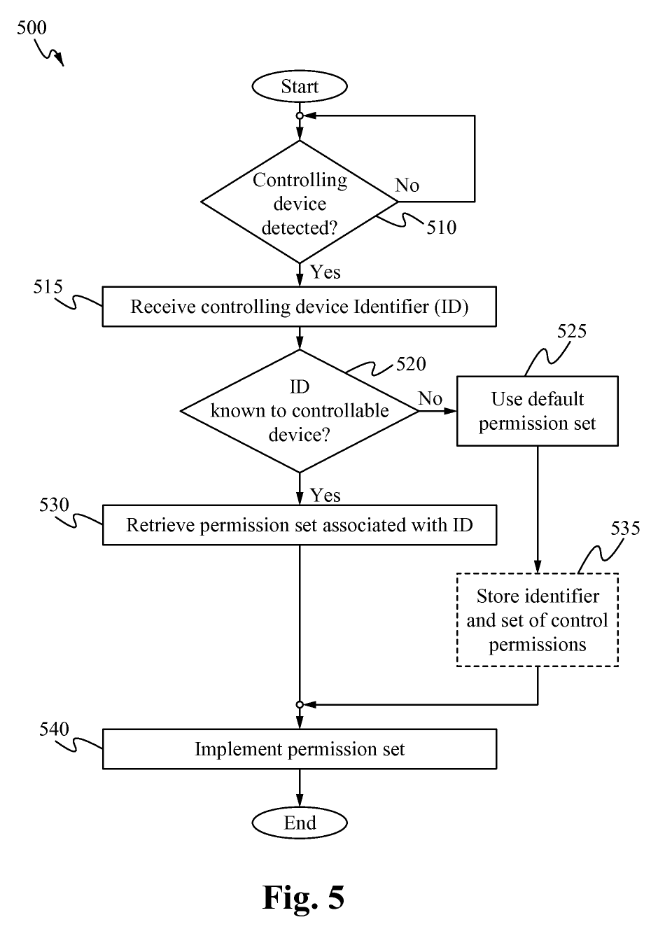

FIG. 5 is a method 500 of enabling control of a controllable device according to some embodiments. At step 510, a controllable device checks to see whether a potential controlling device is detected. If a controlling device is detected, at step 515 the controllable device receives an identifier of the controlling device. If no controlling device is detected, the method loops back to continue checking for the presence of a controlling device at step 510. After an identifier of the controlling device is received at step 515, the identifier is looked up by the controllable device at step 520 to determine whether the identifier is known to the controllable device. If the identifier is known, then at step 530 the controllable device retrieves a set of control permissions associated with the identifier. If the identifier is not known, then at step 525 a default set of control permissions is created. At step 535, the method can optionally store the identifier and default set of control permissions associated with the identifier in order to keep a log of an attempt by an unknown device to access the controllable device. At step 540 the set of control permissions is implemented and the method ends.

FIGS. 6A-6D illustrate a mountable, independently operable tablet PC 120 having pins for mount detection 126 and charging 127. FIG. 6A shows a front view of a mountable, independently operable tablet PC 120 with the mount 125 in its stored position. FIG. 6B shows a rear view of the tablet PC 120 with the mount 125 in its stored position. FIG. 6C shows another rear view of the tablet PC 120 with the mount 125′ in its open position. The mount 125′ comprises a mounting detection pin 126. When the tablet PC 120 is mounted to a desktop PC 110, as shown in FIG. 6D, the mounting detection pin 126 contacts a corresponding pad inside the desktop PC mount 200. Detection of the presence of tablet PC 120 by the desktop PC 110, and detection of the presence of the desktop PC 110 by the tablet PC 120 can be sensed by the contact between the pin 126 and a corresponding contact inside the mount 200. In some embodiments, the mount 125′ comprises charging pins 127, which have corresponding pads inside the mount 200 on the desktop PC 110. When the tablet PC 120 is mounted to the desktop PC 110 and the mounting is detected at pin 126, the tablet PC 120 can request an identifier from the desktop PC 110 and retrieve a set of control permissions associated with the identifier of the desktop PC 110. If the desktop PC 110 contains a set of control permissions enabling selective control of the desktop PC 110 charging function through pins 127 in the mount 200, associated with an identifier of the tablet PC 120, then the tablet PC 120 can request that the desktop PC 110 charge the tablet PC 120. Once the tablet PC 120 determines that it is fully charged, the tablet PC 120 requests that the desktop PC 110 stop charging the tablet PC 120. FIG. 6D shows a front view of the tablet PC 120 being mounted into a mount 200 on the desktop PC 110 using the mount 125′ in the open position.

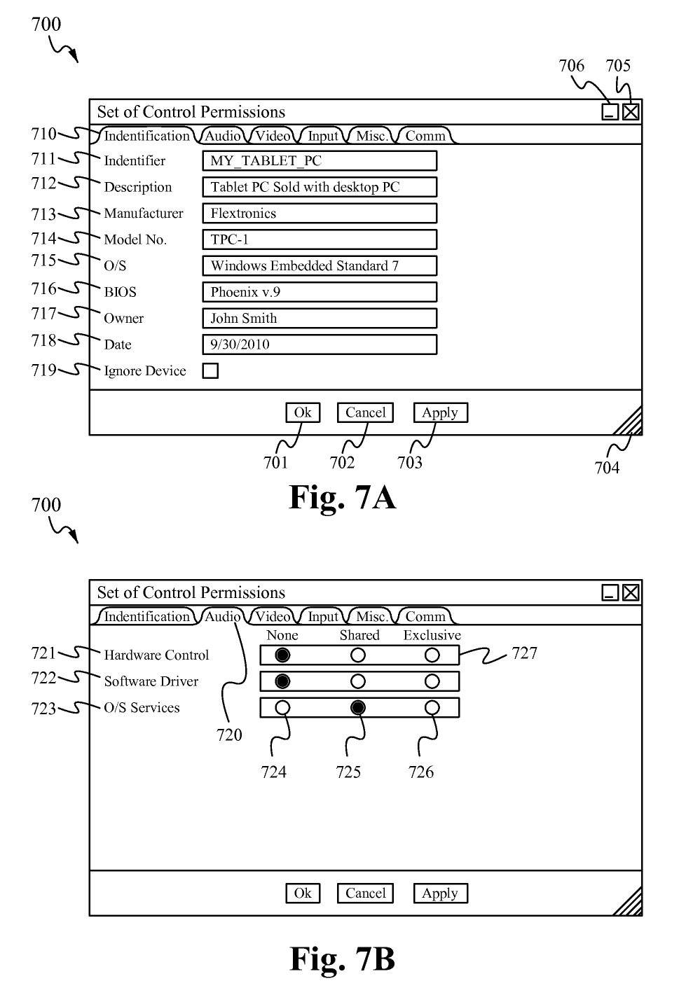

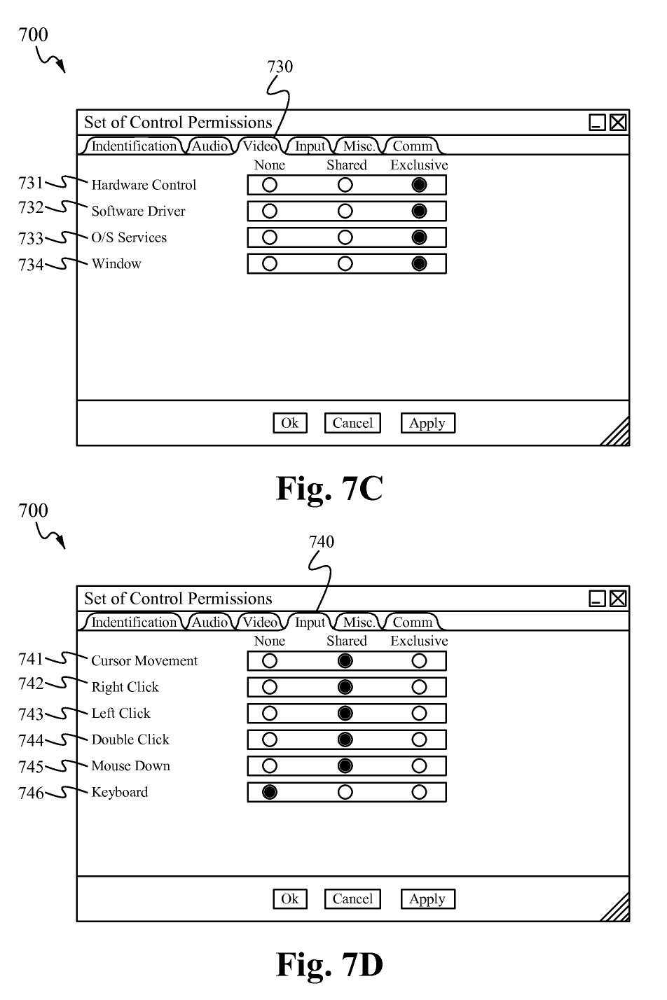

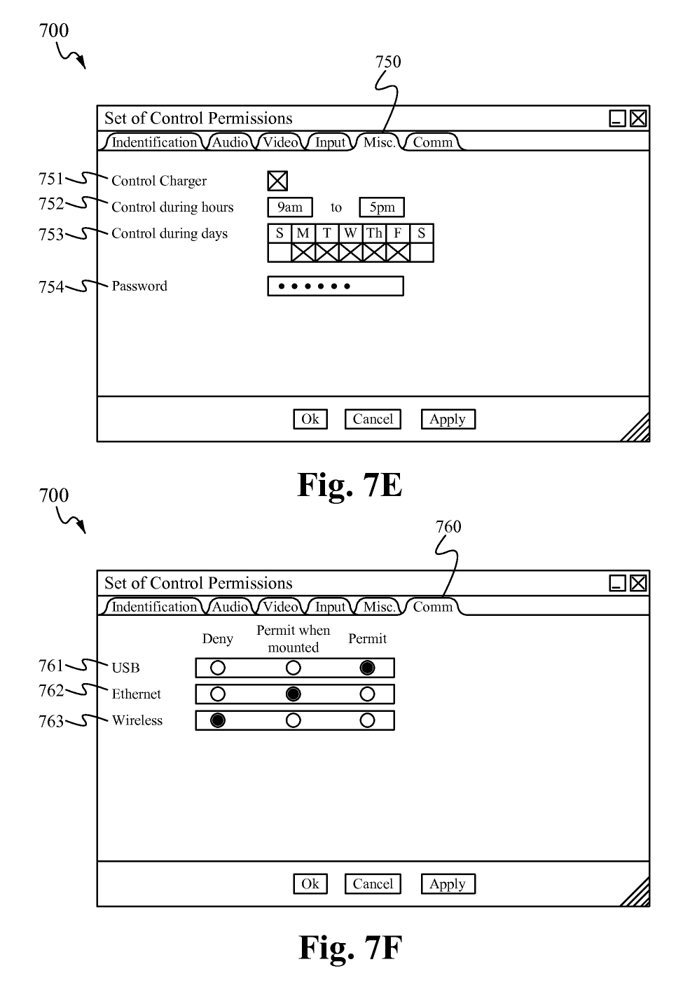

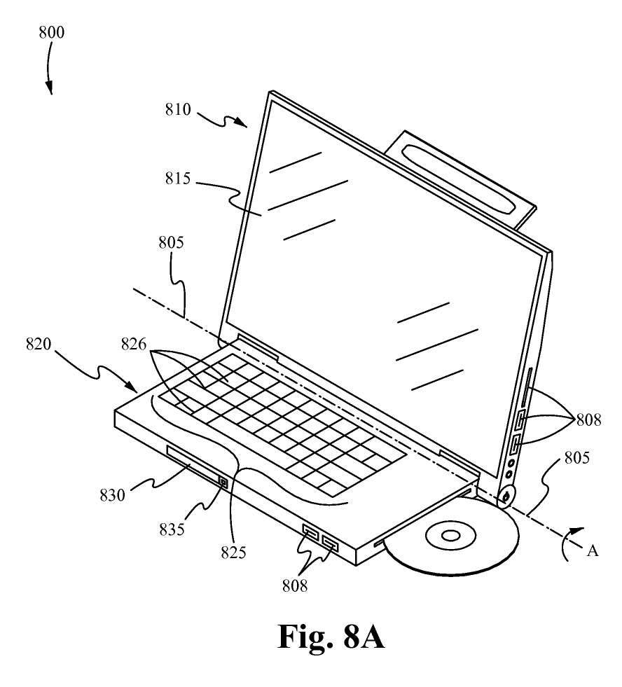

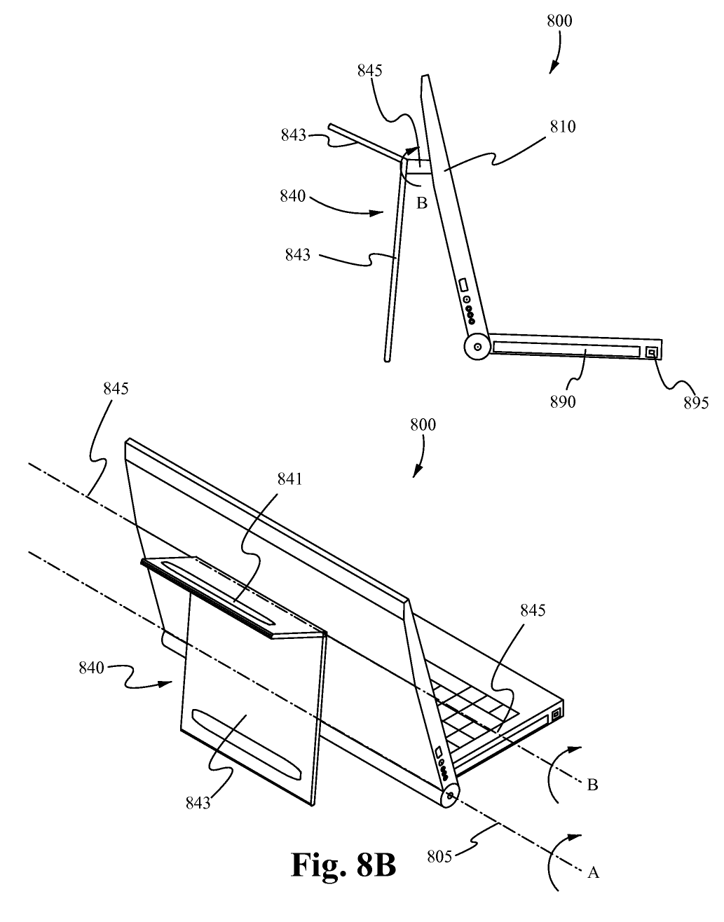

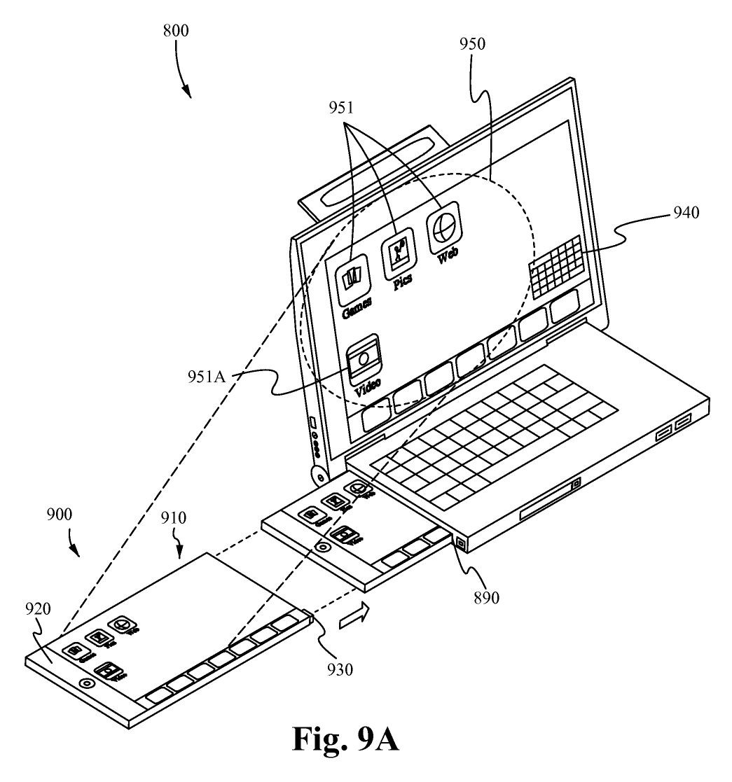

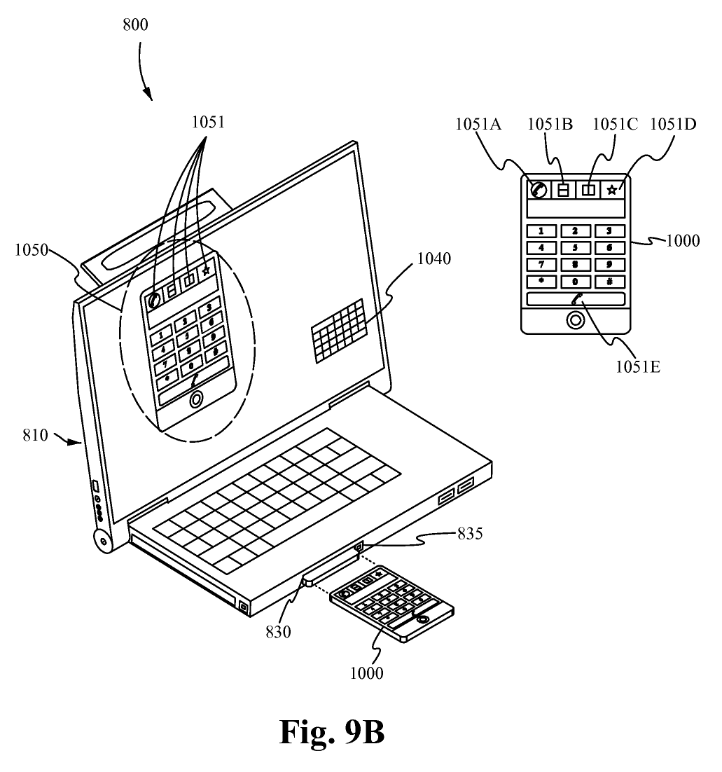

FIGS. 7A-7F show an embodiment of the properties of a set of control permissions for a detected and identified controlling device. FIG. 7A shows the identification properties of a set of control permissions associated with a detected controlling device having an identifier “MY_TABLET_PC” 711. A tabbed dialog box 700 of the properties of a set of control permissions can comprise an identification tab 710. The tabbed dialog box 700 can further comprise common controls such as an “OK” button 701, a “Cancel” button 702, an “Apply” button 703, a window sizing control 704, a close window control 705, and a window minimization control 706. These controls are common to the window, independent of the tab control currently displayed, as is known in the art. FIGS. 7A-7F describe the properties of the Set of Control Permissions for a controlling device having an identifier. If a controllable device does not possess a certain property, or group of properties, then the corresponding controls in the tabbed dialog boxes will appear grayed out, or inoperative. Inoperative controls can be set in software to not permit the any control of the property, or the controls can be automatically set to “no control” for the property. The identification tab 710 includes a field for an identifier 711 of the controlling device whose properties are described in the dialog box. The identifier can be typed in by a user, by a factory technician, or can be obtained from device information such as manufacturer, model number, serial number, or a combination of these. A description field 712 is a textual, human-readable field to describe the controlling device. Fields for the manufacturer 713, model number 714, operating system type and revision 715, and BIOS version 716 of the controlling device can be stored according to well-known techniques. Properties can further include the owner 717 of the controlling device, and the date 718 upon which the controlling device first became known to the controllable device. A global “ignore” flag 719 can be used to deny any control of the controllable device by the controlling device. Setting the “ignore” flag 719 can be used to automatically set all other properties fields to “no control”, or can be used as an override flag to deny control by a controlling device without setting the individual control properties to “no control.”

FIG. 7B shows the audio properties of a set of control permissions, according to some embodiments. The tabbed dialog box 700 can comprise an audio control permissions tab 720. Audio control permissions can include hardware level control 721, control of audio software driver functionality 722, and audio operating system services control 723. Each control can have a radio button corresponding to “no control” 724, “shared control” 725, or “exclusive control” 726. The settings in each group of radio buttons 727 for each property are mutually exclusive. If “none” is selected for a property, then “shared” and “exclusive” are de-selected, as is well-known in the art. Radio buttons can also be logically set by making a specific selection. For example, selecting “exclusive” hardware level control logically means that the software driver control 722 and the operating system services control 723 could be automatically set to “none.” Selection of exclusive hardware control can be the best choice where high-bandwidth control is needed, such as for streaming video and audio from a desktop PC to a digital picture frame with audio properties.

FIG. 7C shows the video properties of a set of control permissions, according to some embodiments. The tabbed dialog box 700 can further comprise a video control permissions tab 730. Video control properties can include hardware level control 731, control of video software driver functionality 732, video operating system services control 723, and control over a specific window on a display 734.

FIG. 7D shows the input properties of a set of control permissions, according to some embodiments. The tabbed dialog box 700 can also comprise an input permissions table 740. Input control properties can include cursor movement 741, right-click events 742, left-click events 743, double-click events 744, mouse down events 745, and keyboard events 746. As described above, control can be “no control”, “shared control”, or “exclusive control.” Configuration of the input control permissions, in conjunction with other permissions, can enable a “Gamer” mode where each player has an electronic device, and each electronic device permits some control by the other player's electronic device.

FIG. 7E shows the miscellaneous properties of a set of control permissions, according to some embodiments. The tabbed dialog box 700 can additionally comprise a check box 751 permitting the controlling device to charge the controlled device. The effective hours of permission can be limited to certain times 752 and certain days 753. A password can be required for a controlling device as a prerequisite to being permitted any control over the controllable device. The foregoing set of control permissions is exemplary and non-limiting. One skilled in the art can add to or delete from the set of control permissions.

FIG. 7F shows the communication properties tab. The communications properties can be used to limit ways in which a controlling device is allowed to communicate with a controllable device. For example, a user choose not to permit any device to communicate with his desktop PC by wireless communication. Or, a user may limit communication with his desktop PC to only devices coupled to a mount on the PC.

Controlled Electrical Appliance Housed within the Controlling Electrical Appliance

FIGS. 8A-9B show an alternate embodiment of interoperating controlling and controlled devices. Specifically, the controlled electrical appliance, such as a tablet PC, smartphone, or Pocket PC, is docked into and housed within the controlling appliance, such as a desktop PC. To that end, in FIG. 8A, a desktop PC 800 is presented from a front view. The desktop PC 800 comprises a display member 810 and an interface portion interface member. The display member 810 comprises a screen 815. Preferably, the screen 810 is a touchscreen. The interface member 820 comprises a keyboard 825. The keyboard 825 can be a light touch keyboard or other keyboard not requiring the deep compression of keys 826. In the example provided, the desktop PC 800 also has a hinge 805 to allow rotation about the axis A. For ease in portability or stowing the interface member 820 can be folded onto the display member 810 for a smaller form factor. The desktop PC further comprises several interface ports 808, such as serial, parallel, USB, Firewire, HDMI, or any other kind of known, convenient, or application specific port. Optionally, the desktop PC 800 includes a disc reader 812 for receiving and reading optical discs, such as Compact Discs (CD), Digital Video Discs (DVD) or Sony's Blu-Ray® (BD). As can be appreciated, the desktop computer 800 comprises several components normally found in a computing device, such as processors and co-processors, video processors, volatile and non volatile memory, and the like.

Preferably, the desktop PC 800 comprises a receptacle 830 for receiving a second electrical appliance (not shown). The desktop PC 800 comprises instructions, via software or hardwired, for recognizing and ultimately controlling or cooperating with the second electrical appliance in a manner similar to what has been described above and shall be described in greater detail below. The receptacle 830 comprises an ejector 835 for ejecting the second electrical appliance.

FIG. 8B shows a rear view and a side view of the desktop PC 800. A kickstand handle 840 is rotatably coupled to the back surface of the display member 810 by a hinge 845. The hinge 845 enables rotational motion along the axis B. For easy stowage, a support portion 843 can be positioned flat against the back surface of the display member 810. When the desktop PC 800 is in use, the support portion 843 is extended away from the back surface of the display member 810 to prop the desktop PC 800 such that the screen 815 faces the user (not shown). In some embodiments, when the support portion 843 is rested flat, a handle portion 845 rotates accordingly as it is affixed to the support portion 843. Stated differently, the handle portion 845 is extended away from the back surface of the display member 810 such that a user is able to grab the handle portion 845 for carrying. The handle portion 845 comprises an opening 841 so a user can easily carry the desktop PC 800. The desktop PC 800 should be in a folded position (along the axis A of FIG. 8A) when being carried. Alternatively, the handle portion 845 and the kickstand portion 841 can rotate independently of each other, and both be positioned flat against the back surface of the display member 810.

When seen from a side view, the support portion 843 is seen extended away from the display member 810. The kickstand 840 is rotated about the axis B such that the support portion 843 props the desktop PC 800 up and the screen 815 faces a user (not shown). From the side view, a second receptacle 890 is shown. The second receptacle 890 is configured to receive a larger portable electronic appliance than is the first receptacle 830. By way of example, the second receptacle 890 can house a tablet computer (not shown). The second receptacle comprises a connection terminal (not shown) for making an electrical connection with a device to be housed within the second receptacle 890. The connection terminal can comprise both a communication module and a charging means. The communication module can be any known, useful, or existing communication standard, such as USB, HDMI, IEEE 1394 (Fire Wire), serial or parallel. Alternatively, any application specific or form factor specific terminal connector can be utilized. For optimum space efficiency, the charging means and communication module can be in the same terminal or closely spaced. Preferably, a second ejector 895 is provided to eject the tablet computer from the second receptacle 890. Advantageously, a user of multiple portable electrical appliances can house them simultaneously within the desktop PC 800. As will be described below, the functionality of any inserted device can be enjoyed or utilized by the user through the interface member 820. Furthermore, any display for a portable electronic device that has been inserted into the desktop PC 800 can be wrapped in a window for display on the screen 815 of FIG. 8A. For example, if a smartphone comprises cellular telephony or broadband access capability, the capability can be utilized by the desktop PC 800 without cumbersome wire-bound coupling which also requires the user to carry a wire such as a USB cable, to couple two devices. Other prior art solutions allow for a smartphone or tablet computer to enable a “Wi-Fi” hotspot. The smartphone (not shown) connects to the internet via a broadband connection such as 3G or 4G and then generates a highly localized IEEE 802.11 Wi-Fi signal that another Wi-Fi enabled device, such as a laptop, can connect to. However, such a solution is extremely draining of battery life of a smartphone and because of the wireless nature of the connection, extra security precautions such as WEP or WSK encryption must be enabled. Even with such encryption, it is still possible for an unauthorized person to gain access to a Wi-Fi signal. The several embodiments of the system described herein allows for coupling of two electrical devices, where one device takes control of another's resources and capabilities, without cumbersome wires or porous wireless connections.

FIG. 9A shows the desktop PC 800 receiving a tablet PC 900. The tablet PC 900 is inserted into the second receptacle 890 of FIG. 8B. The tablet PC 900 comprises a screen 910 and interface buttons 920. Preferably, the screen 910 is a touch sensitive screen so that the screen 910 can also be used as an interface with the tablet PC 900. Tablet PCs are highly portable and useful for either professionals or for leisure since they generally have high processing capability and high level functions including text, spreadsheet and other document generation and control software such as Microsoft Office™ or Sun Microsystems' Open Office™. Any other software can also be implemented, such as CAD programs, simulation programs, or the like. Advantageously, a tablet PC generally does not require a pared down or “portable” version of such software. Because of its robust processing capability and high RAM and permanent memory capacities, the actual version of the software used in desktop and laptop PCs are usable in tablet PCs. In addition to full versions of popular software, tablet PCs also runs several proprietary applications, such as games, calendars, etc.

When the tablet PC 900 is docked within the second receptacle 890 of the desktop PC 800, a connection terminal 930 makes contact with a connector (not shown) within the second receptacle 890. Although a protruding terminal 930 is shown in the exemplary drawing, a flat or recessed terminal can be advantageous to give the tablet PC 900 a smooth, featureless form factor for optimum portability. When the contact between the tablet PC 900 and desktop PC 800 is made, a handshake occurs. The term “handshake” as used herein signifies the intercommunication between two systems or devices that first occurs when the systems or devices are intercoupled. Embedded software or hardware within the terminals or on a separate processing unit can be programmed or otherwise configured to detect a coupling, either by mechanical means or electrical means. By way of example, a small switch can be positioned within the second receptacle 890 that is triggered when the tablet PC 900 is inserted. A corresponding switch can be positioned on an external surface of the tablet PC 900. During the handshake, the desktop PC 800 recognizes the tablet PC 800 and vice versa. In some embodiments, pre-determined access permissions on board the tablet PC 900 are automatically triggered to give the desktop PC any level of permission that has previously been granted. Similarly to the embodiments shown in FIGS. 6A-6D, the desktop PC 800 enables selective control of a charging resource in the second receptacle 890 by the tablet PC 900. The desktop PC 800 detects the presence of tablet PC 900 and displays an icon 940 on the desktop PC display 815 indicating that the tablet PC 900 has been detected and identified, and that a set of control permissions has been retrieved and implemented on the desktop PC 900. The set of control permissions on the desktop PC 900 enable selective control of the charging means in the second receptacle 890 by the tablet PC 900. An icon 940 on the desktop PC display 815 indicates that the tablet PC 900 can selectively control the charging function on the desktop PC 800. When the tablet PC 800 reaches full charge, the tablet PC 900 can turn off the charging function of the desktop PC 900. When the charging function is turned off, the icon 940 can indicate that the charging function is turned off. By way of example, the icon 940 is a miniaturized version of the regular contents of the screen 910 of the tablet PC 900 when the tablet PC 900 is not docked within the desktop PC 800.

In some embodiments, when the icon 940 is called, such as by double clicking the icon 940, a window wrapper 950 appears. The window wrapper 950 corresponds to the screen 910 of the tablet PC 900. Preferably, the window wrapper 950 has the same look and feel and interface characteristics of the screen 910 of the tablet PC 900. Stated differently, the window wrapper 950 serves and acts as the screen of the tablet PC 900 would, except that the screen 910 of the tablet PC 900 is a layered window wrapper 950 on the screen 810 of the desktop PC 800. The window wrapper 950 can be manipulated in any of the well known ways that window applications are used and configured. For example, the window wrapper 950 can be maximized to cover the entirety of the screen 810 of the desktop PC 800, or the window wrapper can be minimized into icon form such as the icon 940 or into a systems tray or into an instruction backlog. The window wrapper 950 can be sized by grabbing a corner (usually by holding a mouse button down) and extending or contracting the window wrapper 950. Furthermore, the user can configure any number of skins that the window wrapper 950 can be wrapped in. User configurable skins can be sports teams, musicians, art works, patterns, or the like. Several icons 951 within the window wrapper 950 represent applications, files, or other content stored on the tablet PC 900 that can be accessed via the keyboard 825 or other interface feature of the desktop PC 800, since it follows naturally that screen 910 or interface buttons 920 on the tablet PC 900 are inaccessible when the tablet PC 900 is docked. However, a user is able to access any resource on the tablet PC 900 via the window wrapper 950. The window wrapper 950 can be programmed in any convenient scheme or language according to the operating system that the desktop PC 800 runs. By way of example, if the user wishes to access a video resource from the tablet PC 900, the user can call the video icon 951A by double clicking. The video resource is called from an internal memory of the tablet PC 900 and the video imagery is displayed on the screen 810 of the desktop PC 800. The user is able to manipulate the video file as if the file existed in a memory of the desktop PC 800. Alternatively, video imagery can be confined to the window wrapper 950, or any portion of the window wrapper 950. Since the window wrapper 950 is a representation of what would have been displayed on the screen 910 of the tablet PC 900, a second window (not shown) can open inside the window wrapper 950 to display the video. The second window wrapper can be manipulated just as any other window. In addition, the second window can be dragged out of the window wrapper 950 and onto the screen 810 of the desktop PC 800.

Furthermore, security is an important feature for users of portable electronics. The several embodiments shown in this disclosure can be used for many purposes, many of which can require security considerations. For example, the tablet PC 900 can be assigned to employees of a workplace to enhance workplace efficiency. The employee can then either dock the tablet PC 900 into a desktop PC 800 or couple in any other way described herein. Advantageously, the user need not be confined to a single office space, and can use the files and applications within the tablet PC 900 at any available docking station of desktop PC 800. However, it is desirable to ensure that only an authorized person is docking the tablet PC 900 to a desktop PC 800 or other dock, since the dock or desktop PC 800 can interact and implement control configurations in the tablet PC 900, and vice versa. Alternatively, it may be desirable to allow only docking or coupling with certain desktop PCs or docking stations to better control distribution of files or information. To that end, a feature contemplated to protect the security of the contents of the tablet PC 900 is a security clearance that pops up automatically on the screen 810 of the desktop PC 800 or other dock when a coupling is detected. For example, the user can be prompted to enter a username and password associated with the tablet PC 900 in order to access its contents or set control permissions within the tablet PC 900. Furthermore, levels of security can be implemented. For example, a first level of security granted to a user can allow sharing of memory and charging resources only, so that files on the tablet PC 900 can be accessed by the desktop PC 800 and that the tablet PC 900 can be charged. More advanced controls, such as settings for communication modules and other access as described below can be more highly secured with a second level of password access. Alternatively, biometrics, such as a fingerprint scanner, can be implemented to gain any level of access.

### Sharing of Processing and Memory Resources

As described above in other embodiments, the tablet PC 900 and the desktop PC 800 can each have their own separate processing capabilities. These processing capabilities can include math processing, instruction processing, video processing, audio processing, or any other computations that follow a set of instructions. In the example given above, a user clicks on the Video icon 951A to call a video file, and a video is displayed within the wrapper 950 or elsewhere as described. The instruction to call the video file originates from the desktop PC 800, and it follows naturally that a processing resource on board the desktop PC 800 queue the instruction by placing the instruction in temporary or cache memory. The processing resource (or alternatively a separate processing resource) within the desktop PC 800 then routes the instruction to a processing resource on board the tablet PC 900. The processing resource of the tablet PC 900 receives and queues the instruction to call the video file into temporary memory such as cache or an instruction buffer register. The instruction buffer register can be a separate processing resource on board the tablet PC 900. In some embodiments, when the instruction to call the video file is executed, a video processing resource on board the tablet PC 900 decodes and constructs video from the video file. Alternatively, the encoded video file on board the tablet PC 900 is transferred to temporary memory on board the desktop PC 800, where a video processing resource decodes and plays the video file. Advantageously, since both the tablet PC 900 and the desktop PC 800 have processing capabilities, multiple applications can be run more smoothly. The user can be using a processing heavy application such as a simulation program that is being executed by a processing resource on the desktop PC 800. If the user desires to call a video or audio file from the tablet PC 900, the processing required to do so can be handled by a processing resource on board the tablet PC 900 without interrupting any instruction executions being done by the processing resource on the desktop PC 800. Furthermore, In some applications, especially computation intensive applications, it is desirable to employ multiple processing resources to one task. To that end, a processing resource on board the tablet PC 900 and a processing resource on board the desktop PC 800 can be configured to co-operate to execute instructions either automatically or by user configuration. Certain computation intensive applications can automatically configure multiple processing resources from both the tablet PC 900 and the desktop PC 800 to co-operate. Preferably, such computation intensive applications prompt a user to allow the controlling desktop PC 800 to completely overtake the processing resources of the controlled tablet PC 900 and use those resources as is necessary. An option can be provided to the user in the form of a pop up window to either dedicate all available processing resources to a computation intensive application or task, or to leave any particular processing resources free for other uses.

Furthermore, both the desktop PC 800 and the tablet PC 900 have individual, separate permanent and volatile memory. The permanent and volatile memories can be solid state, optical or magnetic disc based, or any other type of permanent or volatile memory appropriate for a specific application (such as solid state RAM for volatile memory). Drawing from the example above, when the user uses the keyboard 825 of the desktop PC 800 to call a video file within a memory of the tablet PC 900, the video file can be accessed directly through that memory. Such a process is especially efficient if a processing resource, such as a video driver, on board the tablet PC 900 is also executing the command to play the video. However, the video file can be transferred to a volatile memory on board the desktop PC 800 and then be executed with a processing resource on board the desktop PC 800. Again drawing from the example given above, the desktop PC 800 and its processing resource are executing a computation heavy simulation program. The user wishes to access a video file having notes or information regarding the work the user is doing, and the user accesses the video file to review the notes. The controlling device, the desktop PC 800, is able to prioritize processing resources both on board the desktop PC 800 and the tablet PC 900. Because a processing resource on the desktop PC 800 is executing a computation heavy application, the desktop PC 800 sets a control permission for the tablet PC 900 to call the video file from its own memory and to execute the video file to be played in the window wrapper 950. The reverse situation is also contemplated. The processing resource on board the tablet PC 900 can be executing the computation heavy program. Then, when the user calls a video file, a processing resource on board the desktop PC 800 prioritizes the instruction and queues it based on which processing resource is best able to execute the instruction. The video file is then transferred to a volatile memory on board the desktop PC 800 and executed by a processing resource thereon.

In the examples given above, the desktop PC 800 is the controlling device. Alternatively, the desktop PC 800 is a “dumb” docking unit which is controlled by the tablet PC 900. Stated differently, in some embodiments the desktop PC 800 is a docking station with minimal or no processing resources that relies on the tablet PC 900 for control. Once the tablet PC 900 is docked into the receptacle 890, the tablet PC 900 provides all processing resources. After a security logon prompt is passed, a set of control permissions pass from the tablet PC 900 to the desktop PC 800 and any or all resources such as charging, interface, display, or the like are controlled by the tablet PC 900. Advantageously, in such an embodiment, the desktop PC 800 is much more cost effective. From the example above regarding a place of business, employees can be assigned tablet PCs 900 and work stations can have “dumb” desktop PCs 800 with docking receptacles 890 that any employee can use at any time, effectuating a more efficient and nimble businessplace. For example, a user can dock a tablet PC 900 into a “dumb” desktop PC 800 in any location of a workplace and print a document using a printer that is linked to the desktop PC 800.

### Sharing of Communications Resources

In addition to sharing of processing resources, the desktop PC 800 and a second device docked therein can share communications resources. FIG. 9B shows the desktop PC 800 receiving a smartphone 1000 into a second docking port 830. The docking port 830 comprises and eject button 835 for ejecting the smartphone 1000. Although the smartphone 1000 is used throughout this example, a similarly equipped tablet PC 900 of FIG. 9A can have similar connectivity and interoperability.

Several means and ways of connectivity are available, including TCP/IP, HTTP, and the like for wire bound internet broadband connectivity. Generally, a local area network (LAN) is set up so that several computers can connect to the internet at broadband speeds by the use of a standard CAT-5 cable. The connection is inherently robust because it is wire bound rather than radio transmission based. As is well known, practically all desktop and laptop computers come equipped with a CAT-5 cable connection jack for accessing the internet or an intranet through a LAN. Furthermore, most desktop and laptop computers are equipped with Wi-Fi connectivity. Wi-Fi is well known in the art and needs not be detailed here. However, it is also known that both Wi-Fi and wirebound LAN networks, while effectuating the greatest access speed, require a connection point, such a router or modem, to access the internet.

In the past decade, broadband connectivity has been introduced into cellular phones and has become more and more prevalent, allowing essentially limitless access to the full internet on a smartphone. Mobile broadband (strictly speaking Mobile Internet as the QOS doesn't meet international Broadband definitions) is the name used to describe various types of wireless high-speed internet access through a portable modem, telephone or other device. Various network standards are be used, such as GPRS, 3G, WiMAX, LTE, Flash-OFDMA, IPW, iBurst UMTS/HSPA, EV-DO and some portable satellite-based systems. However mostly the term refers to EVDO (sister system to CDMA-1), EDGE on GSM and HSPDA/HSUPA/HSPA on UMTS/3G/Foma. Such systems piggyback on the mobile phone infrastructure (EDGE, HSPA etc actually share spectrum with voice calls, which have priority). LTE and Mobile WiMax are other standards that are data only, using VoIP for voice. Flash-OFDMA, IPW (derived from CDMA) and iBurst are also Data only networks. Devices that provide mobile broadband include: PC cards also known as PC data card or Connect cards, USB modems, USB sticks often called “dongles,” phones with data modems and portable devices with built-in support for Mobile Broadband (like notebooks, netbooks and Mobile Internet Devices (MIDs)). Notebooks with built-in Mobile Broadband Modules are offered by all leading laptop manufacturers in Europe and Asia including: Asus, Dell, Lenovo (previously IBM), HP, Fujitsu, Toshiba, Micro-Star International and Acer. Collectively, there is generally a separate wireless connection for voice and for mobile broadband, although mobile broadband can be used for voice with applications such as Skype and Google Voice, or other VoIP applications.

Referring back to FIG. 9B, when the smartphone 1000 is inserted into the docking port 830, a handshake and coupling occurs as described in the several embodiments above and summarized below. An icon 1040 appears on the screen 810 of the desktop PC 800. The icon 1040 is a miniaturized representation of the screen 1010 of the smartphone 1000. When the user calls the icon 1040 by double clicking, a window wrapper 1050 is generated. Preferably, the window wrapper 1050 provides an interface that is the same look and feel as the smartphone's screen 1010. When docked, the smartphone 1000 allows for control permissions in a manner described above. Preferably, those control permissions include control of any communications modules within the smartphone 1000. Stated differently, the desktop computer 800 is able to take control of a communications resource within the smartphone 1000 and use it as a communications module of its own. Prior art solutions call for wired coupling of a smartphone and a portable or desktop computer. Still other prior art solutions allow for a localized Wi-Fi network to be generated by a smartphone which a desktop or portable computer can then access. However, each has its drawbacks. In the first example, a separate wire must be provided in order to form a connection. In the second example, the Wi-Fi network generated by the smartphone can be accessed by others, and also causes a rapid battery drain in the smartphone. In both examples, both the smartphone and the portable or laptop computer must be accounted for, causing needless clutter.

A user is able to access the voice dialing capability of the smartphone 1000 through the window wrapper 1050. The window wrapper 1050 has 5 exemplary icons, a phone icon 1051A for activating dialpad, a call log icon 105 lB to view recent incoming, outgoing and missed calls, a contacts icon 1051C where the user can access all of their contacts' information, and a favorites icon 1051D for quick dialing their most frequently called contacts. A call icon 1051E dials a number as entered into the dialpad. Preferably, when the instruction to place a phone call is made, the user is able to use a microphone and speakers on board the desktop PC, or a headset plugged into an interface jack to speak and hear. The Desktop PC 800 can have its own internet connectivity as well. For example, the desktop PC can be wired via LAN or connected to a router through a Wi-Fi network. Since CDMA does not allow voice and internet communications simultaneously, the user can continue accessing the internet while making a call over the smartphone's communications module. Also, the desktop PC 800 can control any broadband connectivity on board the smartphone 800, and access the internet through the smartphone 800. In some embodiments, it can be desirable to mount an antenna within the desktop PC 800 that couples to the communication module within the smartphone 800.

### Coupling of Devices

A first electronic device having a display (“controlled device”) and a second electronic device having a display (“controlling device”) can be coupled mechanically, electrically, communicatively, or by a combination of these. In a preferred embodiment, a desktop PC comprises a mount for detachably coupling the tablet PC to the desktop PC. Electronic devices can also be coupled electrically using a cable such a USB cable. The USB cable contains pins for DATA+, DATA−, V_{CC} and Ground. Electronic devices can be communicatively coupled using any known communication means such as Ethernet, RS485, RS232, wireless, I²C, clocked serial I/O, IEEE-1394 FireWire, USB or other communication protocol.

In a preferred embodiment, a user performs an initial, one time coupling that requires both devices to be under the physical control of the user. During this initial coupling, the two devices can each retrieve and store an identifier of the other device, thereby ensuring that the user can control which devices are permitted selective control of another one of the user's electronic devices. Such a requirement helps prevent unauthorized access or hacking by wireless devices which could communicatively couple to a user's device without the user's knowledge.

In some embodiments, a user may own a tablet PC, a desktop PC, and a digital picture frame. The user couples the desktop PC once to the tablet PC, and once to the digital picture frame. When coupled, the devices detect and identify one another as described below. The user then couples the tablet PC once to the digital picture frame. Thereafter, all three devices are known to one another, and coupling can be done wirelessly. In an alternative coupling process, when two devices are coupled together, each can learn the identifiers of all of the devices known to the other device.

### Detecting a Controlling Device

In a preferred embodiment, a desktop PC includes a mount for detachably coupling a tablet PC to the desktop PC. The desktop PC can detect the tablet PC by including a detection means in the mount. A device can be detected by an electrical contact in the mount which makes or breaks a circuit. The mount can alternatively include a switch, such as a momentary switch, which is depressed when the tablet PC is mounted to the desktop PC and is released when the tablet PC is detached from the mount. The mount can alternatively include a sensor such as an optical sensor which detects an absence of light when the devices are coupled, or a magnetic “Hall Effect” sensor which detects a magnet in the tablet PC mount when the devices are mounted together. Instead of mounting, a controlling device can be detected by an electrical or communicative coupling of the tablet PC and the desktop PC. A controlling device can also be detected by a communicative coupling, such as by a wireless interface.

### Identifying a Controlling Device

In a preferred embodiment, after the tablet PC is coupled to the desktop PC, the tablet PC initiates a communication session with the desktop PC. The communication session can begin with a request for the identifier of the desktop PC by the tablet PC. The desktop PC can respond with an identifier. Alternatively, a pattern of sensors, switches, or contacts similar to those described above for detection can be used to determine a hardware identifier of the tablet PC mounted to the desktop PC. In some embodiments, a set of three (3) contacts in the mount of the tablet PC and a set of three (3) corresponding pads inside the mount on the desktop PC, can be used to establish an identifier of a device based on a binary pattern sensed in the contacts and pads. Utilizing three contacts yields 2³=8 distinct electronic device identifiers, as is well-known in the art. Any number of address pins could be used to establish an identifier. Using a hardware identifier based on detection means in the mount has the benefit of aiding in the prevention of unauthorized requests for a set of permission controls via a wireless communication channel One skilled in the art will recognize that the above-described means for detecting and identifying a controlling device could be combined into a single pair of communication contacts in the mount which would serve both the detection and identification functions.

### Charging a Device

In a preferred embodiment, a desktop PC comprises a mount with detection and identification means as described above. The mount can further comprise a pair of pins applying a voltage to a corresponding set of pads on the mating tablet PC mount. Charging can also be accomplished via the V_{CC} and ground pins on a USB cable. Alternatively, the tablet PC can couple a charging cable to a charging port on the desktop PC which applies a charging voltage to the tablet PC. A tablet PC is a controlling device having a rechargeable power supply. When the tablet PC is coupled to the desktop PC, the tablet PC is detected and identified by the desktop PC. A set of control permissions is retrieved and implemented for the tablet PC by the desktop PC. The tablet PC commands the desktop PC to charge the tablet PC. If the set of control permissions allows the tablet PC to control the desktop PC charging function, then the charging function is turned on by the desktop PC. When the tablet PC is charged, the tablet PC commands the desktop PC to stop charging the tablet PC.

### Retrieving Control Permissions

Once a controlling device is detected and identified by the controllable device, the controllable device can retrieve and implement a set of control permissions associated with the identifier of the controlling device. In a preferred embodiment, the set of control permissions associated with an identifier of the controlling device can be stored on the controllable device. In a preferred embodiment, a controlling desktop PC is detected and identified by a controllable tablet PC. The tablet PC looks up the identifier of the desktop PC in a memory on the tablet PC. If the identifier is present in the tablet PC memory, then a corresponding set of control permissions associated with the identifier is retrieved and implemented on the tablet PC thereby enabling selective control of a resource on the tablet PC by the desktop PC. If the identifier of the desktop PC is not present on the tablet PC, then the tablet PC can create a default set of control permissions for the desktop PC and optionally can associate the identifier of the desktop PC with the set of control permissions, and store the control permissions. Alternatively, a user can edit the default set of control permissions associated with the identifier of the desktop PC, and store the control permissions. In some embodiments, the control permissions can be retrieved from a source accessible to the tablet PC. In addition, an electronic device manufacturer is able to create a default set of control permissions for a make and model of electronic device made by the manufacturer. The manufacturer can then make the default set of control permissions accessible to requesting controllable devices. In some embodiments, the manufacturer makes a default set of permissions for a make and model of their device available via the Internet. In some embodiments, persons other than the user or manufacturer of an electronic device can create and store a permission set for a particular use of an electronic device, and the permission set can be downloaded by the controllable device via the Internet. In still other embodiments, a set of control permissions associated with an identifier of the controlling device can be stored on, and retrieved from, the controlling device. Such an embodiment is particularly useful when a cooperative relationship is set up between two electronic devices with each device controlling a resource of the other electronic device. A set of control permissions for each device can be created and stored on both devices in order to quickly setup a cooperative relationship of permissions between the two devices.

### Example Configurations

The following example configurations describe specific ways that a pair of electronic devices can interoperate in accordance with the presently-claimed invention. The examples are illustrative and are not intended to be limiting.

### Dual Screen PC

In this configuration, a desktop PC is a controlling device coupled to a controllable digital picture frame having audio capabilities. The digital picture frame detects and identifies the desktop PC. A set of control permissions is retrieved from the digital picture frame memory and implemented on the digital picture frame. The set of control permissions enables the desktop PC to selectively control the display and audio features of the digital picture frame. A communication session is initiated between the desktop PC and the digital picture frame. The desktop PC requests exclusive use of the digital picture frame video and audio to play a movie. In some embodiments, the application playing the movie is running on the desktop PC, not on the digital picture frame. In some embodiments, the application playing the movie is running on the digital picture frame. The desktop PC transmits audio and video data to the picture frame, and the digital picture frame displays the video and plays the audio in accordance with the set of control permissions for the desktop PC.

### Tablet PC Charger

In this configuration, a desktop PC with a mount having charging pins is a controllable device. A tablet PC is a controlling device. A user mounts the tablet PC to the desktop PC. The desktop PC detects and identifies the tablet PC, and retrieves a set of control permissions enabling selective control, by the tablet PC, of the desktop PC charging pins in the mount. A communication session is initiated between the devices. The tablet PC has a rechargeable power source. The tablet PC reads its own rechargeable power source level by well-known methods. If the power source level is below maximum, the tablet PC commands the desktop PC to turn on the charging function to the charging pins in the mount. When the tablet PC determines that its rechargeable power source level is at maximum, the tablet PC commands the desktop PC to turn off the charger pins in the mount. The tablet PC and the desktop PC are otherwise independently operable.

### Remote Control of Desktop PC

In this configuration, a tablet PC can remotely control the inputs of a desktop PC, and the desktop PC can control the display of the tablet PC. In a preferred embodiment, the tablet PC and the desktop PC are coupled together a first time so that each device has detected and identified the other device, and each device has stored a set of control permissions associated with the identifier of the other device. Subsequently, the tablet PC and desktop PC each detect and identify the other by wireless communication. A set of control permissions associated with the identifier of the tablet PC is retrieved and implemented on the desktop PC. The set of control permissions enable the tablet PC to control inputs to the desktop PC. A set of control permissions associated with the desktop PC is retrieved and implemented on the tablet PC. The set of control permissions enable the desktop PC to control the tablet PC display. A chess game is running on the desktop PC. The tablet PC has a touch screen. The user of the tablet PC makes a hand movement on the touch screen of the tablet PC. The hand motion on the tablet PC produces a corresponding input movement on the desktop PC. The desktop PC is playing a chess game and processes the input as a chess move. The desktop PC updates its display to show the results of the chess move. The desktop PC updates the display of the tablet PC to match the display of the desktop PC. This gives the appearance that the chess game application is running on the tablet PC, when in fact the chess game is only running only on the desktop PC. The tablet PC is effectively being remotely controlled by the tablet PC. Using a second tablet PC and shared control of the desktop PC inputs between the first and second tablet PCs, two users could play chess on a desktop PC with a large screen, while sitting on a couch across the room from the desktop PC using their tablet PC's to take turns making chess moves on the desktop PC.

In operation, a method of enabling selective control a resource of an electronic device having a display begins with the electronic device, called the controllable device, detecting the presence of another device, called the controlling device. Detection of the controlling device can be by the devices being coupled together by the insertion of the controlled device into the controlling device into a housing or receptacle. Detection can also be by communicative, rather than physical, coupling. A controllable device can poll for the presence of any controlling devices on the communication channel A controlling device can poll for the presence of controllable devices on the communication channel. When a controllable device detects the controlling device's poll, the controlling device has been detected by the controllable device. Once a controlling device is detected, a communication session is initiated between the devices. The controllable device requests, from the controlling device, an identifier associated with the controlling device. The controlling device furnishes an identifier to the controllable device via the communication channel. The identifier can be any identifier of the controlling device such as a serial number of the device, CPU ID, MAC address, an IP address, a user-defined name, or other identifier. The controllable device receives the identifier and looks it up to see whether the controlling device identifier is known to the controllable device. A controllable device can request more than one identifier from the controlling device, or a password, or other authentication from the controlling device. Such authentication can include the controllable device requesting answers to one or more security questions. A controllable device can also require that permission to implement a set of control permissions must be granted manually by a user of the controllable device, even if the identifier of the controlling device is known to the controllable device. If the identifier of the controlling device is not known to the controllable device, a default set of control permissions can be used. A default set of control permissions can specify that the controlling device is not permitted any control over the controllable device. The set of control permissions associated with the device identifier can be retrieved by looking them up in storage on the controllable device. The set of control permissions can also be retrieved by querying a server in communication with the controllable device. The set of control permissions can also be entered manually. Once the set of control permissions is established, the controlling device can request service from the controllable device in accordance with the set of control permissions. A request for service can be implemented under any method such as COM, DCOM, CORBA, WCF, RPC, or by launching an applet, an object, a process, or thread on the controllable device. The request for service can also be implemented using a proprietary communication protocol. A request can be fulfilled by the controllable device by passing the request to an operating system service, by calling a device driver function, or by interacting directly with the hardware of the controllable device. The implementation of the requested service can be also be an abstraction layer over any existing implementation for the device such that the service of requests for control in accordance with the set of control permissions is implemented as a device-specific agent residing on the controllable device. Control by a controlling device can be terminated in a variety of ways. A controllable device can terminate the control by a controlling device through a user explicitly terminating the control, by the expiration of a specified time or date window for control, by a user revoking a particular permission in set of control permissions, by a user powering off the controllable device, or by terminating communication with the controlling device. A controlling device can terminate control of the controllable device by terminating communications with the controllable device, by powering off of the controlling device, by sending a message to the controllable device requesting termination of control, or by not requesting any control of the controllable device.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications are able to be made to the embodiments chosen for illustration without departing from the spirit and scope of the invention as defined by the appended claims.

1. A system comprising:
a. a first electronic device including a first processor, a first display, a receptacle for receiving a second electronic device, the receptacle having a first communication module, and a memory programmed with instructions implementing a method of enabling, by the first electronic device, selective control of a resource of the second electronic device accordance with a set of control permissions associated with an identifier of the second electronic device when the second electronic device is housed within the receptacle, and;
b. a second electronic device including a second processor, a second display, a second communication module, an input device, a memory, and an identifier.

2. The system of claim 1 wherein the first communication module and second communication module operate to enable the first electronic device to detect the presence of the second electronic device and to retrieve the identifier of the second electronic device.

3. The system of claim 1 wherein the first processor and second processor operate to enable the first electronic device to retrieve a set of control permissions associated with the identifier of the second electronic device.

4. The system of claim 1 wherein the first electronic device and the second electronic device are each independently operable from the other.

5. The system of claim 1 wherein the first electronic device is a desktop computer, the second electronic device is a tablet computer detected and identified by the desktop computer 1 and the tablet computer implements a set of control permissions enabling selective control of the tablet computer display by the desktop computer.

6. The system of claim 5 wherein the set of control permissions further enables selective control of the tablet computer audio by the desktop computer.

7. The system of claim 1 wherein the first electronic device further comprises a charging means for the second device, and the set of control permissions enable the second device to selectively control a charging means.

8. The system of claim 1 wherein the first electronic device is a desktop computer, the second electronic device is a smartphone detected and identified by the desktop computer, the smartphone having broadband connectivity means, and the desktop computer implements a set of control permissions enabling selective control of the smartphone broadband connectivity means by the desktop computer.

9. The system of claim 1 wherein the first electronic device is a desktop computer, the second electronic device is a smartphone detected and identified by the desktop computer, the smartphone having cellular telephony means, and the desktop computer implements a set of control permissions enabling selective control of the smartphone cellular telephony means by the desktop computer.

10. The system of claim 9 wherein the set of control permissions enable selective control of the smartphone broadband connectivity means, thereby enabling broadband connectivity in the desktop computer.

11. A method of enabling selective control of a resource of an electronic device having a display comprising implementing, by the electronic device, a set of control permissions for a detected controlling device having a display, based on an identifier of the controlling device, when the electronic device is inserted into the controlling device.

12. The method of claim 11 wherein a resource is one of a video resource, an audio resource, a memory resource, and an wireless connectivity resource.

13. The method of claim 11 wherein the wireless connectivity resource comprises cellular telephony connectivity.

14. The method of claim 11 wherein the wireless connectivity resource comprises cellular broadband connectivity.

15. The method of claim 11 wherein a resource is the display on the electronic device, and the set of control permissions enables the controlling device to control the display on the first electronic device.

16. The method of claim 11 wherein a resource is a cellular broadband resource on the first electronic device, and the set of control permissions enables the second electronic device to control the cellular broadband connectivity of the second electronic device by the cellular broadband resource on the first electronic device, thereby enabling cellular connectivity in the controlling device.

17. The method of claim 11 wherein the set of control permissions for the controlling device enables the controlling device to exclusively control a resource on the electronic device.

18. The method of claim 11 wherein the enabling selective control of a resource of the electronic device is independent of an application running on the controlling device.

19. The method of claim 11 wherein a plurality of sets of control permissions are associated with an identifier of the controlling device.

20. The method of claim 11 wherein a set of control permissions corresponds to a selective control mode.

21. The method of claim 20 wherein a selective control mode is one of an audio mode, an audio-visual mode, an input mode, and a charging mode.

22. The method of claim 20 wherein a selective control mode is implemented on the electronic device based on the identifier of the detected controlling device.

23. The method of claim 20 wherein audio-video selective control mode is implemented on the electronic device based on the identifier corresponding to a particular desktop computer controlling device.

24. The method of claim 20 wherein the controlling device is detected and identified a first time during a coupling the electronic device with the controlling device, and subsequently the controlling device is detected and identified by communicating with the electronic device.

25. The method of claim 20 further comprising terminating the selective control of the electronic device by the electronic device.

26. An electronic device comprising:
a. a processor;
b. a display;
c. a receptacle for receiving a controlled device;
d. a communications module, and;
e. a computer-readable medium programmed with instructions for enabling selective control of a resource of the electronic device by implementing a set of control permissions for a detected controlled, based on an identifier of the controlled device when the controlled device is housed within the receptacle.

27. The electronic device of claim 26 wherein the receptacle further comprises a communication module for detecting the controlled device.

28. The electronic device of claim 26 wherein the receptacle further comprises a means for identifying the controlled device.

29. The electronic device of claim 26 further comprising a rechargeable power source.
